(19) United States
(12) Patent Application Publication
(10) Pub. No.: US 2026/0213625 A1
(43) Pub. Date: Jul. 23, 2026

(54) MOTOR HAVING A ROTARY ENCODER, AND SUPPORT ELEMENT FOR A MOTOR HAVING A ROTARY ENCODER

(71) Applicant: Dr. Fritz Faulhaber GmbH & Co. KG, Schönaich (DE)

(72) Inventors: Sanjay JADHAV, Filderstadt (DE); David Richard MIKO, Gyömrö (HU); Davide FREY, Pazzallo (CH)

(21) Appl. No.: 19/141,580

(22) PCT Filed: Dec. 20, 2023
(86) PCT No.: PCT/EP2023/086902

§ 371 Date: Jun. 20, 2025

(30) Foreign Application Priority Data
Dec. 22, 2022 (DE) 10 2022 134 622.6

(51) Int. Cl. H02K 11/215; G01B 7/30; G01D 5/14; H02K 21/22

(52) U.S. Cl. CPC H02K 11/215; G01B 7/30; G01D 5/145; H02K 21/22; H02K 2211/03

(57) ABSTRACT

The present invention relates to a motor (1) with at least one stator (2), at least one rotor (3) and at least one shaft (4), wherein at least one rotary encoder (5) is arranged on the motor (1), and wherein the shaft (4) is connected to the rotor (3).

A motor (1) and a carrier element (11) for a motor (1), which ensure a compact design with high precision of the rotary encoder (5) while simultaneously reducing manufacturing and assembly effort, are realized by arranging at least one carrier element (11,26) at at least one first axial end (10) of the motor (1), that at least one sensor component (6) of the rotary encoder (5) rests at least partially on a side of the carrier element (11,26) facing away from the shaft (4) in the axial direction, in order to position the sensor component (6) in the axial direction relative to the shaft (4), and that the carrier element (11,26) has at least one lateral guide means (12) to position the sensor component (6) in a form-fitting manner in the radial direction in relation to the shaft (4).

The invention relates to a motor, particularly an electric motor. The motor comprises at least one stator and at least one rotor. The rotor is connected to a shaft. At least one rotary encoder is arranged on the motor.

Motors are known from the state of the art in a variety of designs for different applications. For many applications, especially in medicine and industrial automation, information about the rotational speed and angular position of a motor's rotor is of crucial importance, for example, to detect angular changes of objects and determine their position. For this purpose, motors usually have rotary encoders, also called encoders or angle encoders, which are based on optical or magnetic measuring principles, for example.

The components of a rotary encoder require space on the motor, which conflicts with the desire for a compact design of the motor in certain applications. Furthermore, for the most precise detection, a very accurate arrangement of the components of a rotary encoder relative to each other is required, which places high demands on the manufacturing and assembly of the components.

Motors with rotary encoders known from the state of the art already fulfill these combined requirements very well, but there is always a need for more compact designs with further increased precision.

Therefore, the present invention aims to provide a motor and a carrier element for a motor that enable a compact design with high precision of the rotary encoder while simultaneously reducing manufacturing and assembly effort.

The aforementioned problem is solved in a motor of the type mentioned above with the features of the characterizing part of claim 1, namely by arranging at least one carrier element at at least one first axial end of the motor. The carrier element is particularly arranged in such a way that it has a side facing away from the shaft and a side facing towards the shaft in the axial direction along a longitudinal axis of the motor shaft. On the side of the carrier element facing away from the shaft, at least one sensor component of the rotary encoder is in contact with the carrier element with at least a part of its surface, particularly with a part of a front surface of the sensor component oriented towards the shaft. In particular, the sensor component is arranged on the carrier element in such a way that a front surface of the sensor component is substantially aligned in an imaginary plane to which the longitudinal axis of the shaft is a normal.

The rotary encoder is also referred to as an encoder or angle encoder and provides output signals that allow, for example, the rotational speed and/or angular position of the motor to be determined. The rotary encoder is designed, for example, as an absolute encoder or incremental encoder.

The carrier element is arranged on the motor in such a way that it has a fixed position in relation to the shaft. By contacting the carrier element, the sensor component is advantageously positioned in the axial direction relative to the shaft. The positional tolerance in the axial direction is therefore very low and can be considered essentially zero. Furthermore, the carrier element has at least one lateral guide means. The lateral guide means is particularly formed on the side of the carrier element axially facing away from the shaft. The lateral guide means positions the sensor component in a form-fitting manner in the radial direction in relation to the shaft.

“Axial direction” means a direction that runs parallel to the longitudinal axis of the shaft. “Radial direction” means a direction that runs radially, i.e., particularly substantially orthogonal, to the longitudinal axis of the shaft.

The motor is designed, for example, as a DC motor, particularly with sliding contacts, or as a brushless DC motor, particularly with electronic commutation.

Consequently, the sensor component is positioned relative to the shaft in both axial and radial directions through interaction, particularly form-fitting interaction, with the carrier element. The lateral guide means encloses the sensor component over at least a part of its circumference so that it cannot move in any of the lateral directions. Preferably, the lateral guide means encloses the sensor component substantially completely. The lateral guide means positions the sensor component against movement in a plane orthogonal to the longitudinal axis of the shaft.

The sensor component of the rotary encoder is particularly a component that contributes as a sensor or part of a sensor to determining the rotational speed and/or angular position of the rotor. The sensor component is, for example, part of a magnetic rotary encoder or an optical rotary encoder.

For magnetic rotary encoders, a multi-pole magnet is particularly attached to the rotor shaft. When the shaft rotates, the change in the magnetic field is detected by Hall sensors, which can then be evaluated to determine the rotational speed and/or angular position.

Optical rotary encoders use an encoding disc with a scale attached to the motor shaft. A distinction is made between reflective and transmissive optical rotary encoders. In reflective optical rotary encoders, an electromagnetic wave, particularly light from an LED, is reflected from reflective surfaces on the encoding disc and captured by detectors, particularly photodetectors. In transmissive optical rotary encoders, an electromagnetic wave, particularly light from an LED, passes through openings in the encoding disc and is captured by detectors, particularly photodetectors, on the other side of the encoding disc.

Preferably, the sensor component is a chip of a magnetic rotary encoder with at least one Hall sensor, preferably a plurality of Hall sensors. For example, the chip with the Hall sensor or Hall sensors is substantially rectangular or square in shape.

Alternatively, it is provided that the sensor component is a chip with components of an optical rotary encoder, particularly a reflective one, preferably with at least one LED, photodetectors, and the required electronics. The chip is preferably substantially rectangular or square in shape.

The invention has the advantage over the state of the art that the positional tolerances in axial and radial directions can be minimized. In the radial direction, the remaining tolerance results only from the position of the carrier element and is only about 0.06 mm, while in the axial direction, there is virtually no positional tolerance. The tolerance chains in axial and radial directions are reduced to a minimum. The sensor component itself has essentially no size tolerance and can therefore be arranged as the leading component for positioning only on the carrier element. The carrier element aligns the sensor component exactly in relation to the shaft, which particularly allows the overall length of the motor to be reduced and simplifies assembly, especially shortening assembly time. Tolerances resulting, for example, from varying thickness of a circuit board, varying thickness of the sensor component itself, or varying thickness of a solder joint are thus advantageously minimized.

According to a particularly preferred first embodiment of the motor, it is provided that the sensor component is arranged on a circuit board, for example, soldered onto a circuit board. By guiding only the sensor component on the carrier element for positioning, namely through the lateral guide means in the lateral direction and through contact with the carrier element in the axial direction, the circuit board is also positioned by the positioning of the sensor component. The leading component for positioning is not the circuit board, but the sensor component arranged on the circuit board. The sensor component is particularly an encoder chip of a magnetic rotary encoder, advantageously with Hall sensors.

It is also preferably provided that at least one adapter part is provided, with which the distance to at least one lateral guide means can be bridged. The lateral guide means is configured for a specific size of a sensor component, particularly an encoder chip. If a sensor component is now smaller, an adapter part can be arranged between the sensor component and the lateral guide means to ensure radial alignment for different sizes of sensor components as well. For example, if the lateral guide means is configured for a sensor component size of 4×4 mm, sensor components with a size of 3×3 mm or 2×2 mm can also be positioned using an adapter part.

With this configuration, there is an advantage over the state of the art in that tolerances that arise when mounting a sensor component on a circuit board, for example, the thickness of a solder joint, are irrelevant during assembly, as the positioning of the sensor component with the circuit board on the motor is based solely on the position of the sensor component.

According to a further embodiment, it has also proven advantageous if it is provided that the carrier element has at least one guide wall. The guide wall is preferably the part of the carrier element on which the sensor component rests at least partially, i.e. with a part of its surface, to be positioned axially. Preferably, the guide wall is arranged in such a way that it extends at least partially between the sensor component and the shaft respectively a magnet arranged on the shaft. Preferably, the guide wall is arranged in such a way that it intersects with the longitudinal axis of the motor shaft along its course. The guide wall is preferably arranged in such a way that it extends in a plane to which the longitudinal axis of the shaft is a normal.

The guide wall is advantageously dimensioned in such a way that it remains mechanically unchanged even under a force of up to 40 N, particularly up to 45 N, so that the load does not affect the output signals provided by the rotary encoder. The thickness of the guide wall corresponds approximately to the distance of a magnet attached to the shaft from the guide wall or is smaller than the distance of the magnet attached to the shaft from the guide wall. In this way, the axial length of the motor can be further reduced.

According to a further embodiment, particularly the assembly of the motor can be simplified by forming at least one receiving depression on the carrier element. The sensor component is arranged at least partially in the receiving depression so that side walls of the receiving depression serve as lateral guide means. In the assembled state, the sensor component rests against a guide wall, particularly formed at the bottom of the receiving depression. Especially for a sensor component that is attached to a circuit board, it has proven advantageous if the depth of the receiving depression corresponds only to a part of the thickness of the sensor component, particularly a chip, so that free positioning of the board is ensured and an advantageous contact of the sensor component with the guide wall formed in the receiving depression occurs. The side walls of the receiving depression provide lateral guide means in all lateral directions for the sensor component, so that the receiving depression also aligns the sensor component in the radial direction relative to the shaft respectively the magnet. For example, it is provided that the receiving depression has a substantially rectangular, particularly substantially square, basic shape. These basic shapes are particularly suitable for sensor components designed as encoder chips with Hall sensors.

The receiving depression is advantageously positioned on the motor in such a way that it extends in axial extension of the shaft, i.e., intersects with the longitudinal axis of the shaft. Preferably, the receiving depression is arranged in such a way that the longitudinal axis of the shaft runs substantially through the center of the receiving depression. This allows for advantageous positioning, especially for magnetic encoders, relative to a magnet attached to the shaft.

The positioning of a sensor component, particularly an encoder chip with Hall sensors, can be simplified by providing, according to a further embodiment of the motor, that the receiving depression has at least one circumferential recess in the transition areas between the side walls and the guide wall. This allows for advantageous axial positioning of the sensor component on the guide wall of the receiving depression. In particular, manufacturing-related radii in this transition area are recessed in such a way that they have no effect on the positioning of the sensor component.

For example, it is provided that the recess is designed in such a way that a step, particularly a circular step, is formed on the guide wall on which the sensor component rests.

Alternatively or additionally, it is provided that the receiving depression has at least one corner recess, particularly a corner recess with a radius, in at least one corner area between two side walls. Preferably, at least one corner recess, particularly with a radius, is formed in all four corner areas between two side walls. The corner recess also ensures that manufacturing-related radii on the carrier element have no influence on the positioning of the sensor component in the receiving depression. This design ensures that the sensor component can rest very precisely against the guide wall.

A further embodiment of the motor provides that the guide wall has at least one or exactly one through-opening. The through-opening completely penetrates the guide wall. Preferably, it is provided that at least or exactly two or at least or exactly three or at least or exactly four through-openings are formed in the guide wall. At least one through-opening or at least one of the through-openings preferably serves for the passage of electromagnetic waves, particularly light, of a component of an optical rotary encoder, for example, an LED, and/or for the passage of reflected electromagnetic waves, particularly light. For example, a component of an optical encoder is arranged at at least one through-opening in such a way that an optical focus is positioned centrally in the through-opening. Preferably, it is provided that at least two through-openings, preferably all through-openings, have a truncated cone-like cross-section. The truncated cone-like cross-section is arranged in such a way that the larger diameter of the truncated cone is oriented towards the shaft. The through-openings preferably have a circular shape. This also applies in particular to truncated cone-like cross-sections, which advantageously have a circular shape at every point along their course.

A further embodiment of the motor provides that the sensor component is materially bonded to the carrier element. Preferably, the sensor component is materially bonded in the receiving depression. In particular, the sensor component is materially bonded to the guide wall. Advantageously, it is provided that the sensor component is attached to the carrier element using UV light-cured adhesive. Preferably, it is provided that the carrier element, particularly the guide wall, has at least one through-opening. The through-openings can be used to introduce the adhesive, which distributes itself between the sensor component and the carrier element through capillary action. In particular, the through-opening is at least partially filled with cured adhesive. Preferably, at least two through-openings are present and both are at least partially filled with cured adhesive.

In this embodiment, it is advantageous if the through-openings have a truncated cone-like cross-section that opens towards the shaft. The through-openings can be used to introduce adhesive and are partially filled with adhesive. The increasing cross-section due to the truncated cone shape prevents, particularly due to the capillary effect, the adhesive from protruding on the side of the magnet respectively the shaft. This prevents protruding adhesive from coming into contact with, for example, the shaft or a magnet holder.

When attaching the sensor component with an adhesive, it has proven particularly advantageous if, according to a further embodiment, it is provided that the adhesive contacts at least about half, preferably at least about two-thirds, of a surface of the sensor component, particularly a surface oriented towards the shaft. For example, at least half, preferably at least about two-thirds, of the contact area between a sensor component, for example an encoder chip with Hall sensors, and a guide wall is covered with adhesive.

Fixing the sensor component, particularly by means of a UV light-cured adhesive, to the carrier element has the advantage that after fixing, programming contacts on the sensor component, particularly on a circuit board connected to the sensor component, are accessible to program the sensor component for use. The contacting is preferably done with needle contacts. Only then is the connection, for example of a flat ribbon cable, made to the sensor component respectively to the circuit board connected to the sensor component.

A further embodiment provides that the rotary encoder has at least one holding element connected to the shaft. The holding element is designed, for example, to hold a magnet for a magnetic rotary encoder and/or to hold an encoding disc for an optical rotary encoder. Advantageously, it is provided that the holding element is designed in such a way that the holding element serves or can serve as a magnet holder, particularly in a first assembly orientation, and serves or can serve as an encoding disc holder, particularly in a second assembly orientation.

Depending on the orientation in which the holding element is attached to the shaft, it is either a magnet holder or an encoding disc holder. For example, a first end side of the holding element is designed to accommodate at least one magnet, while a second end side of the holding element is designed to attach an encoding disc for an optical rotary encoder. This design has the advantage that only a single component is required to mount the components for a magnetic rotary encoder or for an optical rotary encoder on a motor, particularly on its shaft.

The holding element has, for example, a substantially sleeve-shaped base body that has a central recess. The central recess is dimensioned in such a way that the holding element can be pushed onto the shaft with the central recess and can be fastened to the shaft. A frontal protrusion is formed on a first end side, on which an encoding disc can be attached. The length of the protrusion corresponds, for example, to about 1.5 times the thickness of the encoding disc. On a second end side, the base body has, in particular, a frontal magnet receiving space that locally expands the diameter of the central recess to accommodate a magnet. A magnet can be fastened in the magnet receiving space. This dual function of the holding element can reduce the number of required components, thereby simplifying manufacturing.

Preferably, the holding element is designed and attached to the shaft in such a way that the holding element defines an axial position of at least one shaft bearing relative to the shaft. This eliminates the need for separate axial fixation of the shaft bearing, which can reduce the overall length. It is also provided that the holding element serves respectively can serve as a magnet holder in a first assembly orientation and serves respectively can serve as an encoding disc holder.

It is particularly preferred that the rotary encoder is designed as a magnetic rotary encoder. According to this design, at least one magnet is rotationally fixed to the shaft with at least one holding element, particularly a magnet holder respectively a holding element functioning as a magnet holder. Preferably, the holding element, particularly the magnet holder, is designed in such a way that the shaft is at least partially inserted into the holding element, particularly the magnet holder, or the holding element, particularly the magnet holder, is pushed onto the shaft. Furthermore, the holding element, particularly the magnet holder, has a magnet receiving space to accommodate the magnet. The magnet is fixed in the magnet receiving space. Preferably, the carrier element is designed in such a way that at least the part of the holding element respectively magnet holder, particularly at least the part of the holding element respectively magnet holder in which the magnet is arranged, is circumferentially surrounded by the carrier element.

A further embodiment of the motor provides that the magnet holder is designed and arranged on the shaft in such a way that the magnet holder defines an axial position of at least one shaft bearing relative to the shaft. The magnet holder is, for example, press-fitted onto the shaft. By constructing the magnet holder to be sufficiently stable and attaching it to the shaft in such a way that positioning of the shaft can be achieved using the magnet holder, an additional ring for positioning the shaft can be particularly omitted. This allows the length of the motor to be further reduced constructively, which has a beneficial effect on the required installation space.

According to a further embodiment of the motor, it is advantageously provided that the motor has at least one housing, and that the housing of the motor is designed in multiple parts. Preferably, the housing has at least one base element, which is made of metal, for example. The rotor and stator are preferably arranged within the base element. Furthermore, the shaft is mounted within the base element. The shaft preferably protrudes from both sides of the base element of the housing, on one side to be connected for the intended purpose of the motor, and on the other side to interact with the rotary encoder. The base element is, for example, bell-shaped and closed at the first end side with a support element. At least one shaft bearing for the shaft is preferably arranged on the support element.

At the first end side of the housing, the carrier element is also advantageously arranged, in which the sensor component is positioned and fixed. It is advantageously provided that the carrier element is covered with an end cap. Preferably, the end cap provides an entry option for a flat ribbon cable to contact the sensor component, for example, an encoder chip on a circuit board, at signal contacts.

In particular, to ensure the possibility of using a uniform carrier element with a variety of different motors or motors with different housings, it is advantageously provided according to a further embodiment that at least one adapter element is arranged between the base element and the carrier element. The adapter element can be respectively is connected to both the base element and the carrier element and serves to adapt the carrier element for use with the base element of the motor. Preferably, a variety of different adapter elements are provided for different motors with base elements. It is advantageously provided that the adapter element has at least one recess to route the cables for the motor connection contacts. Preferably, the carrier element and the adapter element have corresponding coding means to define the assembly of the adapter element and the carrier element in only one orientation.

Preferably, it is provided that the carrier element is at least partially inserted into the adapter element. According to a further embodiment, it is therefore advantageously provided that the carrier element has at least one clamping protrusion on at least one circumference with which it is inserted into the adapter element or into the base element of the motor. Preferably, a plurality of clamping protrusions are provided. The clamping protrusions are preferably arranged evenly distributed around the circumference. The clamping protrusions deform when the carrier element and the adapter element are assembled and serve both for positioning and for fixing the carrier element in the adapter element respectively in the base element. Preferably, a press fit is formed between the adapter element and the carrier element.

A further embodiment provides that at least the carrier element has at least one cable recess so that at least two cables can be routed parallel to a longitudinal axis of the motor. The cable recess is preferably designed in such a way that the cables routed in the cable recess do not protrude beyond the contour of the motor in the radial direction, but are nevertheless routed parallel to the longitudinal axis of the motor. As a result, the housing of the motor has an advantageous, constant diameter over its entire length.

Preferably, at least four cables are arranged respectively can be arranged in the cable recess and can be routed parallel to the longitudinal axis. The cable recess is preferably designed in such a way that the cables can be arranged both protruding in the radial direction and in the axial direction. For this purpose, the cable recess is, for example, designed to be open in the radial direction. Depending on the requirements of the application, the cables can be routed axially aligned or radially protruding. The cable recess is preferably designed to follow at least partially the circular shape of the motor. The cable recess is preferably designed and arranged in such a way that the cables routed in the cable recess are parallel to a flat ribbon cable for the rotary encoder. Four cables for the motor are required, for example, for stepper motors. For example, the carrier element has at least one protrusion, wherein the cable recess is routed at least partially in the protrusion. An end cap can be arranged on the protrusion, for example. This ensures that the cables are also routed past the end cap and the diameter of the housing is not enlarged.

It is further provided that the base element of the motor housing has a first outer diameter. The carrier element particularly has a second outer diameter and the end cap particularly has a third outer diameter. Preferably, the second outer diameter and the third outer diameter are approximately equal. Furthermore, it is provided, for example, that the second outer diameter and the third outer diameter are smaller than or equal to the first outer diameter. The outer diameter of the carrier element and the outer diameter of the end cap preferably do not protrude in the radial direction beyond the outer diameter of the base element of the motor. A diameter or a height and a width respectively a diagonal of a sensor component, particularly an encoder chip, is advantageously smaller than the diameter of the motor, particularly of the base element of the motor.

The invention further relates to a carrier element as part of a housing for a motor, particularly according to one of the previously described embodiments. The carrier element preferably has at least one receiving depression, wherein the receiving depression is designed to at least partially accommodate a sensor component of a rotary encoder arranged on a circuit board. Preferably, the receiving depression is designed to accommodate an encoder chip of a rotary encoder with Hall sensors arranged on a circuit board. Preferably, the receiving depression has a substantially square cross-section. Further configurations of the carrier element result from the previously described embodiments, which are referred to here.

Moreover, the invention relates to the use of a carrier element, particularly according to one of the described embodiments, as part of a housing of a motor, to position a sensor component, particularly an encoder chip of a magnetic rotary encoder arranged on a circuit board, in axial and radial directions relative to a shaft of the motor, particularly to a magnet arranged on the shaft. The carrier element has at least one receiving depression, wherein the receiving depression is designed to at least partially accommodate a sensor component of a rotary encoder arranged on a circuit board. Furthermore, the carrier element has at least one guide wall for the sensor component to rest against.

Furthermore, the invention relates to a holding element for a rotary encoder, wherein the holding element can be attached to a shaft of a motor. The holding element is designed in such a way that it serves respectively can serve as a magnet holder for at least one magnet in a first assembly orientation and serves respectively can serve as an encoding disc holder in a second assembly orientation. Depending on the orientation in which the holding element is attached to the shaft, it is thus either a magnet holder or an encoding disc holder. For this purpose, for example, a first end side of the holding element is designed to accommodate at least one magnet, while a second end side of the holding element is designed to attach an encoding disc for an optical rotary encoder. This design has the advantage that only a single component is required to mount the components for a magnetic rotary encoder or for an optical rotary encoder on a motor, particularly on its shaft.

Further advantageous configurations of the invention result from the following description of the figures and the dependent claims.

The figures show:

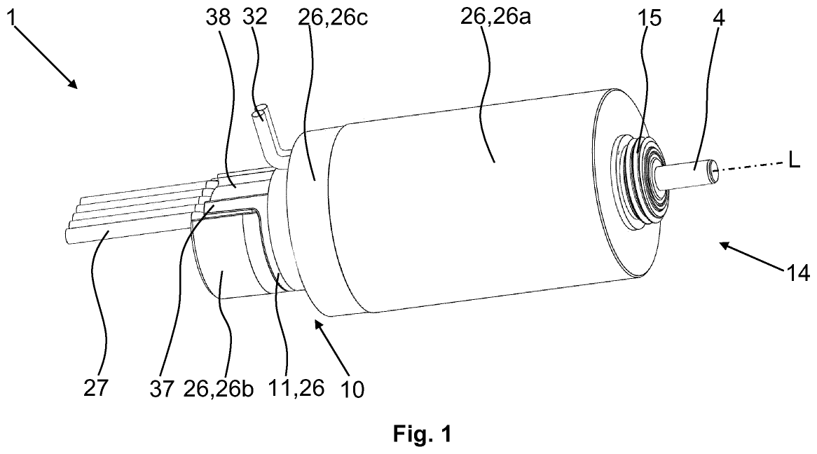

FIG. 1 a perspective view of a first embodiment of a motor,

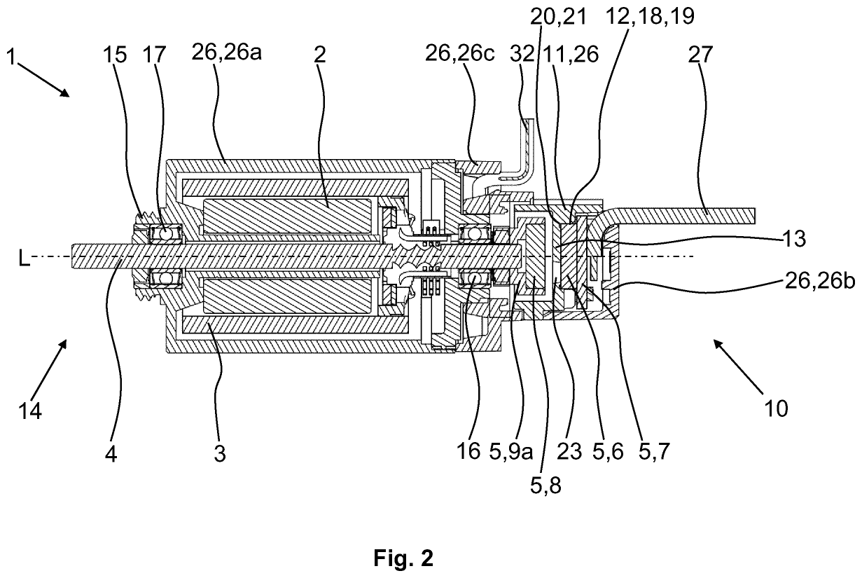

FIG. 2 a sectional view of the motor according to the embodiment of FIG. 1,

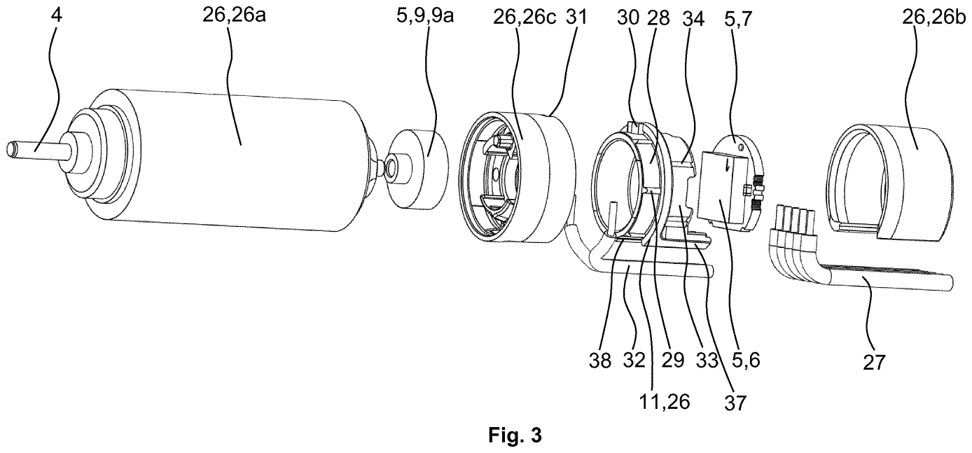

FIG. 3 a perspective exploded view of a second embodiment of a motor,

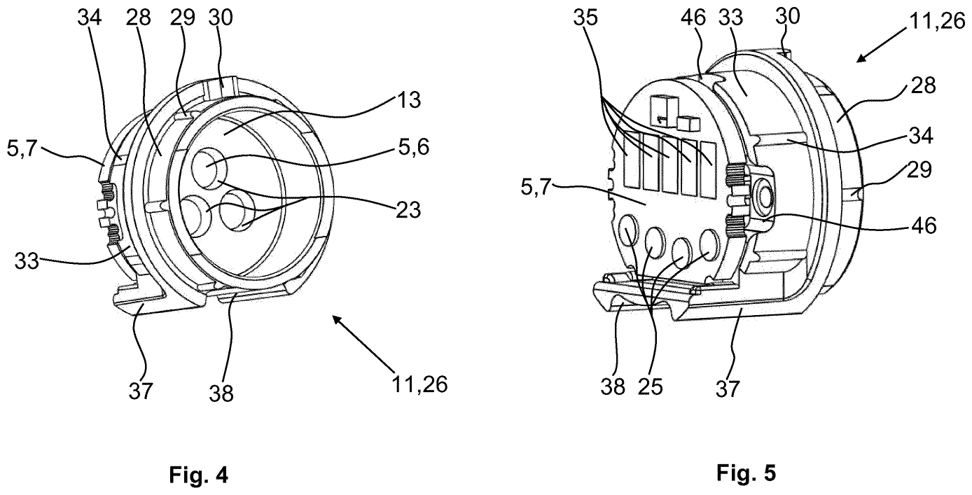

FIG. 4 a perspective view of a first embodiment of a carrier element,

FIG. 5 a second perspective view of the embodiment according to FIG. 4,

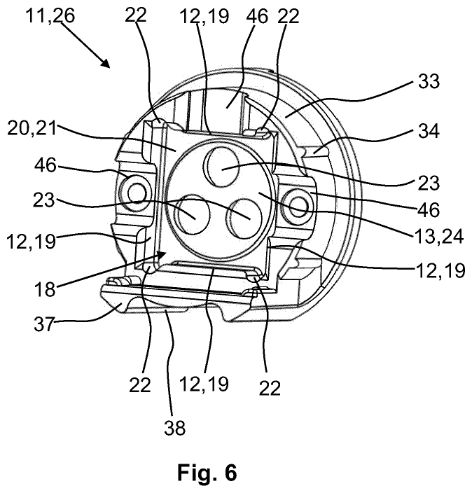

FIG. 6 a perspective view of an embodiment of a carrier element,

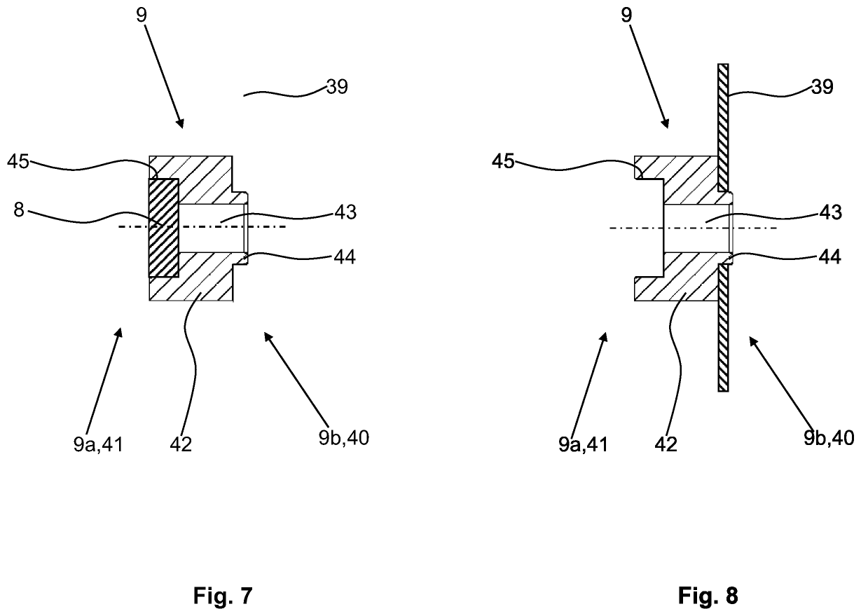

FIG. 7 a section through an embodiment of a holding element,

FIG. 8 a section through an embodiment of a holding element, and

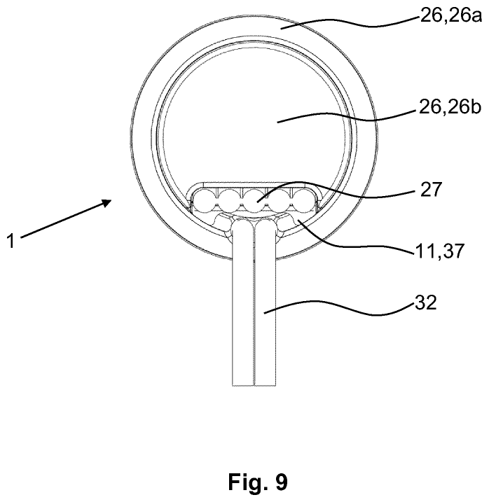

FIG. 9 a rear view of an embodiment of a motor.

In the various figures of the drawing, the same parts are always provided with the same reference signs.

For the following description, it is claimed that the invention is not limited to the embodiments and thereby not to all or several features of described feature combinations; rather, each individual partial feature of the/each embodiment is also significant for the subject matter of the invention in itself, detached from all other partial features described in connection therewith, and also in combination with any features of another embodiment.

FIG. 1 shows an embodiment of a motor 1 in perspective view. FIG. 2 shows the embodiment according to FIG. 1 in a sectional view in a plane that includes the longitudinal axis L of the shaft 4. The motor 1 has a stator 2 as well as an external rotor 3 here. The rotor 3 is connected to a shaft 4. The motor 1 has at least one rotary encoder 5, which is designed as a magnetic rotary encoder in this embodiment. The rotary encoder 5 has a sensor component 6 that is arranged on a circuit board 7, as well as a magnet 8 that is attached to the shaft 4 with a magnet holder 9a.

According to FIG. 1 and FIG. 2, a carrier element 11 is arranged at a first axial end 10 of the motor 1. The sensor component 6 of the rotary encoder 5 rests on a side of the carrier element 11 facing away from the shaft 4 in the axial direction. The sensor component 6 of the rotary encoder 5 is thereby positioned in the axial direction along the longitudinal axis L relative to the shaft 4, particularly relative to the magnet 8. The carrier element 11 has a lateral guide means 12 to position the sensor component 6 in the radial direction to the longitudinal axis L. In particular, the sensor component 6 is positioned in an imaginary plane to which the longitudinal axis L is a normal. The carrier element 11 has a guide wall 13 that is arranged between the sensor component 6 and the magnet 8, and against which the sensor component 6 rests.

According to the embodiment of FIG. 1 and FIG. 2, the motor 1 has a thread 15 at its second axial end 14 opposite to the first axial end 10, to fix the motor 1. The shaft 4 can be contacted for an application at the second axial end 14. According to FIG. 2, the shaft 4 is mounted with a first shaft bearing 16 and a second shaft bearing 17. In this embodiment, the magnet holder 9a is designed in such a way that it positions the shaft 4 relative to the first shaft bearing 16. This eliminates the need for an additional component to fix the shaft 4 to the first shaft bearing 16, thereby shortening the overall length of the motor 1. A base element 26a of the housing 26 of the motor 1 is essentially bell-shaped and is closed at the first end side 10 of the motor 1 with a support element 36. The first shaft bearing 16 is arranged in the support element 36.

FIG. 4 and FIG. 5 show a first embodiment of a carrier element 11 with a sensor component 6 arranged on it with a circuit board 7. FIG. 6 shows the embodiment of a carrier element 11 according to FIGS. 4 and 5 without the sensor component 6 with circuit board 7. According to FIGS. 2 and 6, the carrier element 11 has a receiving depression 18 with circumferentially arranged side walls 19. The side walls 19 serve as lateral guide means 12 for an insertable sensor component 6 and thus serve for the radial positioning of the sensor component 6. The receiving depression 18 has an essentially square basic shape.

In transition areas 20 between side walls 19 and the guide wall 13, a circumferential recess 21 is formed, which allows advantageous contact of a sensor component 6 with the guide wall 13. The recess 21 results in a step 24 being formed centrally in the receiving depression 18, against which the sensor component 6 rests. Furthermore, in all corner areas between each two side walls 19, a corner recess 22 is formed, which has a radius and allows easier insertion of a sensor component 6 into the receiving depression 18.

According to FIGS. 2, 4 and 6, the guide wall 13 of the carrier element 11 has three through-openings 23, which according to FIG. 2 have a truncated cone-shaped cross-section. The larger diameter of the truncated cone-shaped cross-section extends towards the shaft 4 according to FIG. 2. Through the through-openings 23, a UV light-curable adhesive can be introduced when a sensor component 6 is arranged in the receiving depression 18 to glue the sensor component 6 to the guide wall 13. The truncated cone-shaped cross-section of the through-openings 23 prevents adhesive from protruding on the guide wall 13 towards the magnet 8. In the assembled state, the through-openings 23 are at least partially filled with adhesive.

FIGS. 4 and 5 show the carrier element 11 with the sensor component 6 fixed to it and the circuit board 7 arranged on the sensor component 6. The circuit board 7 itself has no contact with the carrier element 11, so that the position of the sensor component 6 with the circuit board 7 relative to the carrier element 11 is determined solely by the accommodation of the sensor component 6 in the receiving depression 18. The sensor component 6 is thus the “leading” component for positioning. When the carrier element 11 is arranged in the motor 1, this results in a very precise radial and axial positioning of the sensor component 6 relative to the shaft 4, particularly relative to the magnet 8 attached to the shaft 4.

Compared to solutions known from the state of the art, where positioning is based on the circuit board, the present invention has the advantage that tolerances arising from the positioning of the sensor component 6 on the circuit board 7 have no influence on the accuracy of the rotary encoder 5.

In the fixed state according to FIG. 5, programming contacts 25 for the sensor component 6 are accessible on the circuit board 7, so that the sensor component 6 can be programmed for use. Only then is a flat ribbon cable 27, shown as an example in FIG. 3, connected to the signal contacts 35 of the circuit board 7.

According to FIGS. 4, 5 and 6, the carrier element 11 has a protrusion 37. In the area of the protrusion 37, the carrier element 11 has a greater length parallel to the longitudinal axis L of the motor 1—see FIG. 2. Furthermore, the carrier element 11 has a cable recess 38, in which up to four cables, for example the connection cables 32, can be arranged in this embodiment. The cable recess 38 is designed in such a way that the cables arranged in it do not protrude in the radial direction. The shape of the cable recess 38 essentially follows the circular contour of the housing 26.

The carrier element 11 also advantageously has at least two or at least three recesses 46. The recesses 46 are provided to accommodate additional components arranged on a circuit board 7, so that these components do not prevent positioning based on the sensor component 6.

FIG. 3 shows an embodiment of a motor 1 in an exploded perspective view. As with the embodiment of FIG. 1, the motor 1 according to FIG. 3 has a housing 26 that is designed in multiple parts. The housing 26 has a base element 26a, the carrier element 11, and an end cap 26b, which covers the sensor component 6, the circuit board 7, and also the contacts of the flat ribbon cable 27 after the sensor component 6 has been fixed to the carrier element 11. The carrier element 11 has a cable recess 38 that runs at least partially in an axial protrusion 37. In the assembled state, the connection cables 32 are arranged in the cable recess 38 so that the connection cables 32 run parallel to the longitudinal axis L and do not protrude in the radial direction. The connection cables 32 then run parallel to the flat ribbon cable 27.

According to FIG. 3, a holding element 9 is provided, which in this embodiment is arranged in such a way that it fulfills the function of a magnet holder 9a. Further details on such a holding element 9 are described in FIG. 7.

Furthermore, in the embodiments of FIG. 1 to FIG. 3, an adapter element 26c is provided between the carrier element 11 and the base element 26a. The carrier element 11 is preferably a uniform component for all motors 1 that can be coupled to the base element 26a via the adapter element 26c. The adapter element 26c is firmly connected to the base element 26a respectively to a support element 36 of the base element 26a (see FIG. 2). For assembly, the carrier element 11 is at least partially inserted into the adapter element 26c. To fix the position, a plurality of clamping protrusions 29 are provided on an outer first circumference 28 of the carrier element 11, which deform when assembled with the adapter element 26c and thereby fasten the carrier element 11 to the adapter element 26c.

Furthermore, the carrier element 11 has a coding means 30, which is designed as a coding protrusion and can interact with a coding means 31, which is designed as a coding recess on the adapter element 26c. This allows only a single orientation of the carrier element 11 relative to the adapter element 26c during assembly. The end cap 26b is pushed onto a second circumference 33 of the carrier element 11. To fix the end cap 26b on the second circumference 33, a plurality of clamping protrusions 34 are arranged on the second circumference 33, which deform when pushed on. The base element 26a, the adapter element 26c, the carrier element 11 and the end cap 26b together form the housing 26 for the motor 1 with rotary encoder 5. The connection cable 32 for power supply to the motor contacts is introduced between the adapter element 26c and the carrier element 11. According to FIG. 1, the connection cables 32 are routed in the radial direction. Alternatively, they could also be routed in the cable recess 38 in the carrier element 11 parallel to the longitudinal axis L. When the connection cables 32 are arranged in the cable recess 38, they run parallel to the flat ribbon cable 27 for connecting the rotary encoder 5. The cable recess 38 advantageously runs at least partially in an axial protrusion 37 of the carrier element 11.

FIG. 7 and FIG. 8 each show a section through an embodiment of a holding element 9 for attachment to the shaft 4 of a motor 1, e.g. according to FIG. 1. The holding element 9 is designed in such a way that it serves both as a magnet holder 9a for a magnetic rotary encoder, particularly in a first assembly orientation, and as an encoding disc holder 9b for an optical rotary encoder, particularly in a second assembly orientation. FIG. 7 shows an embodiment of a holding element 9 with a mounted magnet 8, FIG. 8 shows an embodiment of a holding element 9 with an encoding disc 39 for an optical rotary encoder. Depending on the use, either only the magnet 8 or only the encoding disc 39 is mounted. If the holding element 9 is mounted at one end of the shaft 4 with a first end side 40 leading-first assembly orientation-the holding element 9 fulfills the function of a magnet holder 9a. If the holding element 9 is mounted at one end of the shaft 4 with a second end side 41 leading-second assembly orientation-the holding element 9 fulfills the function of an encoding disc holder 39. Alternatively, however, it is also provided that the holding element only fulfills the function as an encoding disc holder 39 or the function of the magnet holder 9a in a first assembly orientation.

The holding element 9 according to the embodiments of FIG. 7 and FIG. 8 has a base body 42, particularly substantially sleeve-shaped, which has a central recess 43. The central recess 43 is dimensioned in such a way that the holding element 9 can be pushed onto the shaft 4 with the central recess 43. A frontal protrusion 44 is formed on the first end side 40, on which an encoding disc 39 can be attached. The length of the protrusion 44 corresponds, for example, to about 1 to 2 times, particularly 1.5 times, the thickness of the encoding disc 39. On the second end side 41, the base body 42 has a frontal magnet receiving space 45 that locally expands the diameter of the central recess 43 to accommodate a magnet 8. This dual function of the holding element 9 can reduce the number of required components, thereby simplifying manufacturing. The magnet receiving space 45 is dimensioned in such a way that it can accommodate the magnet 8 at least partially, particularly completely.

FIG. 9 shows an embodiment of a motor 1, e.g. according to FIG. 1, in a rear view. In this embodiment, the base element 26a of the housing 26 of the motor 1 has the largest diameter. The diameter of the carrier element 11 and the diameter of the end cap 26b of the housing are smaller than the diameter of the base element 26a and approximately equal. Consequently, the diameter of the carrier element 11 and the diameter of the end cap 26b do not protrude in the radial direction beyond the diameter of the base element 26a of the motor 1. The flat ribbon cable 27 for connecting the sensor component 6, e.g. an encoder chip, is routed above the protrusion 37 of the carrier element 11.

The invention is not limited to the illustrated and described embodiments, but also includes all embodiments that have an equivalent effect in the sense of the invention. It is expressly emphasized that the embodiments are not limited to all features in combination; rather, each individual partial feature can also have an inventive significance in itself, detached from all other partial features. Furthermore, the invention is not yet limited to the combination of features defined in claim 1, but can also be defined by any other combination of certain features of all individually disclosed features. This means that, in principle, practically any individual feature of claim 1 can be omitted or replaced by at least one individual feature disclosed elsewhere in the application.

### LIST OF REFERENCE SIGNS

1 Motor
2 Stator
3 Rotor
4 Shaft
5 Rotary encoder
6 Sensor component
7 Circuit board
8 Magnet
9 Holding element
9a Magnet holder
10 First motor end
11 Carrier element
12 Lateral guide means
13 Guide wall
14 Second motor end
15 Thread
16 First shaft bearing
17 Second shaft bearing
18 Receiving depression
19 Side wall
20 Transition area
21 Recess
22 Corner recess
23 Through-opening
24 Central step
25 Programming contact
26 Housing
26a Base element
26b End cap
26c Adapter element
27 Flat ribbon cable
28 First circumference of 11
29 Clamping protrusion
30 Coding protrusion
31 Coding recess
32 Connection cable
33 Second circumference of 11
34 Clamping protrusion
35 Signal contact
37 Protrusion
38 Cable recess
39 Encoding disc
40 First end side
41 Second end side
42 Base body
43 Central recess
44 Protrusion
45 Magnet receiving space
L Longitudinal axis of shaft 4

1. Motor with at least one stator, at least one rotor and at least one shaft (4), wherein at least one rotary encoder is arranged on the motor, and wherein the shaft is connected to the rotor, wherein
at least one carrier element is arranged at at least one first axial end of the motor, that at least one sensor component of the rotary encoder rests at least partially on a side of the carrier element facing away from the shaft in the axial direction, in order to position the sensor component in the axial direction relative to the shaft, and that the carrier element has at least one lateral guide means to position the sensor component in a form-fitting manner in the radial direction in relation to the shaft.

2. Motor according to claim 1,
wherein
the sensor component is arranged on a circuit board, and that the circuit board is positioned by the positioning of the sensor component.

3. Motor according to claim 1,
wherein
the carrier element has at least one guide wall, that the sensor component rests at least partially against the guide wall, and that the guide wall extends in a plane to which the longitudinal axis (L) of the shaft is a normal.

4. Motor according to claim 1,
wherein
at least one receiving depression is formed on the carrier element, that the sensor component is arranged at least partially in the receiving depression so that side walls of the receiving depression serve as lateral guide means and the sensor component rests against a guide wall formed in the receiving depression (18).

5. Motor according to claim 4,
wherein
the receiving depression is formed in axial extension of the shaft.

6. Motor according to claim 4,
wherein
the receiving depression has at least one circumferential recess at least in the transition areas between the side walls and the guide wall.

7. Motor according to claim 3,
wherein
the guide wall has at least or exactly one, at least or exactly two, or at least or exactly three through-openings.

8. Motor according to claim 1,
wherein
the sensor component is materially bonded to the carrier element.

9. Motor according to claim 8,
wherein
the adhesive contacts at least about half of a surface of the sensor component.

10. Motor according to claim 1,
wherein
the rotary encoder has at least one holding element connected to the shaft.

11. Motor according to claim 10,
wherein
the rotary encoder is designed as a magnetic rotary encoder, and that at least one magnet is connected to the shaft with the at least one holding element.

12. Motor according to claim 1,
wherein
at least one housing is present, that the housing is designed in multiple parts, and that the housing comprises at least one base element and at least the carrier element.

13. Motor according to claim 12,
wherein
at least one adapter element is arranged between the base element and the carrier element, and that the adapter element connects the carrier element to the base element.

14. Motor according to claim 1, wherein
the carrier element has at least one clamping protrusion on at least a first outer circumference.

15. Carrier element as part of a housing for a motor comprising at least one receiving depression, wherein the receiving depression is designed to at least partially accommodate a sensor component of a rotary encoder (5) arranged on a circuit board.

16. Use of a carrier element (11,26) with at least one receiving depression (18), wherein the receiving depression (18) is designed to at least partially accommodate a sensor component (6) of a rotary encoder (5) arranged on a circuit board (7) and has a guide wall (13) for the sensor component (6) to rest against, as part of a housing (26) of a motor (1), to position the sensor component (6) in axial and radial directions relative to a shaft (4) of the motor (1).

17. Motor according to any one of claims 7,
wherein the at least one through-opening has a truncated cone-like cross-section.

18. Motor according to claim 8,
wherein the carrier element has at least one through-opening, and that the through-opening is at least partially filled with a cured adhesive.

19. Motor according to claim 9,
wherein the adhesive contacts at least about half of a surface of the sensor component oriented towards the shaft.

20. Motor according to claim 10,
wherein the holding element is designed in such a way that it can serve as a magnet holder in a first assembly orientation and can serve as a encoding disc holder in a second assembly orientation.

21. Motor according to claim 10,
wherein the holding element is designed and attached to the shaft in such a way that the holding element defines an axial position of at least one shaft bearing relative to the shaft.
